(19) United States
(12) Patent Application Publication
(10) Pub. No.: US 2014/0169516 A1
(43) Pub. Date: Jun. 19, 2014

(54) FUEL RODS WITH VARYING AXIAL CHARACTERISTICS AND NUCLEAR FUEL ASSEMBLIES INCLUDING THE SAME

(71) Applicant: GLOBAL NUCLEAR FUEL - AMERICAS, LLC, Wilmington, NC (US)

(72) Inventors: Randall J. Dunavant, Leland, NC (US); David Grey Smith, Leland, NC (US); Peter R. Diller, Wilmington, NC (US)

(73) Assignee: GLOBAL NUCLEAR FUEL - AMERICAS, LLC, Wilmington, NC (US)

(21) Appl. No.: 13/715,905

(22) Filed: Dec. 14, 2012

(51) Int. Cl. G21C 3/06; G21C 3/32

(52) U.S. Cl. CPC G21C 3/06; G21C 3/32
USPC 376/434; 376/412

(57) ABSTRACT

Nuclear fuel rods have cladding or fuel with physical parameters that substantially change based on axial position within a rod. Parameters include inner and outer cladding and fuel diameters or widths, volume, mass, internal volume, thickness, rod width, etc. Parameters are selected and implemented based on calculated operating conditions and/or desired fuel response at an axial position across an entire rod length and/or fuel assembly position, including both fueled regions and non-fueled zones. Desired parameters can be achieved through fabrication or later alterations. Parameter variations versus axial position and fuel assembly position are intentional and achieve desired fuel properties and responses, such as optimized fuel mass, pressure drop, over-pressurization protection, etc. Fuel rods can be compatible with existing fuel types and replace conventional fuel rods therein.

### BACKGROUND

FIG. 1 is a sectional illustration of a conventional nuclear reactor fuel assembly 10 typically used in commercial light water nuclear reactors for electricity generation throughout the world. Several fuel assemblies 10 are placed in a reactor in close proximity to sustain a nuclear chain reaction. A fluid moderator and/or coolant conventionally passes through fuel assembly 10 in a length-wise (axial) direction, enhancing the chain reaction and/or transporting heat away from the assembly 10.

As shown in FIG. 1, fuel assembly 10 includes multiple fuel rods 14 containing fissile material and extending in the axial direction within the assembly 10. Although not shown in FIG. 1, fuel rods 14 are often seated into a lower tie plate 16 and extend upward into an upper tie plate 17 at ends of fuel assembly 10. Fuel rods 14 are bounded by a channel 12 that forms an exterior of the assembly 10, maintaining fluid flow within assembly 10 throughout the axial length of assembly 10. Conventional fuel assembly 10 also includes one or more conventional fuel spacers 18 at various axial positions. Fuel spacer 18 permits fuel rods 14 to pass through grid-like openings in spacer 18, thereby aligning and spacing fuel rods 14. One or more water rods 19 may also be present to provide a desired level of moderator or coolant through-flow to assembly 12

FIG. 2 is an illustration of an interior of a related art fuel rod 14. As shown in FIG. 2, fuel rod 14 includes one or more fuel elements 22, which are pellets or other similar shapes stacked in an axial direction, within an internal volume or housing formed by cladding 22 of fuel rod 14. Fuel elements 22 include fissile nuclear fuel and generate fission products, which are generally contained by cladding 20 surrounding and providing impermeable containment to pellets 22 and fission products generated therefrom. Fuel rod 14 may include a fueled portion 14a, in which fuel pellets extend, and a non-fueled zone 14b, where open space exists to allow fission product, which can be gasses produced through nuclear fission, accumulation and prevent over-pressurization of fuel rod 14. A hold-down spring 23 in plenum area 14b may compress and generally preserve a position of fuel pellets 22 within fuel rod 14. A thin inner liner 21 (shown in dash) may extend about an interior perimeter of fuel rod 14 to reduce effects of pellet-cladding interaction. Cladding 20 may be formed of a harder and/or stronger zirconium or other alloy, inner liner 21 may be formed of a softer material and extend inward from an inner surface of cladding 20.

As shown in FIG. 2, related art fuel rod 14 has a uniform and constant inner diameter, dic, through its entire axial length. Similarly, fuel pellets 22 each have a uniform width, df, throughout fuel rod 14 that is smaller than dic, so as to prevent rigid contact between pellets 22 and cladding 20. Fuel rod 14 also has a constant outer diameter doc, such that cladding 20 has a uniform thickness throughout fuel rod 14. Such uniformity may aid modular construction of fuel elements, rods, and assemblies, with different rods and parts thereof being useable in a variety of positions within fuel assemblies.

### SUMMARY

Example embodiments include nuclear fuel rods and assemblies containing the same with intentional variations in fuel and/or cladding. For example, fuel elements or cladding that houses a fuel element may be sized, in volume, radii, and/or thickness, based on their axial position in a fuel rod. Inner and/or outer diameters or widths of cladding may have intentional variation along an axial position of an example embodiment fuel rod, from as little as a couple to several hundred mils, even well over doubling conventional or existing sizes. Fuel sizes may also be expanded or reduced proportionally with cladding inner diameter changes at their axial position, such that two fuel elements at different axial positions may have a same axial length yet different volumes and fuel masses. Changes to cladding and/or fuel are made based on conditions at a particular axial position, which can include both fueled regions and non-fueled regions that contain accumulated fission gases. Changes in cladding thickness, fuel rod width, cladding inner/outer diameter proportions, internal volume defined by the cladding, cladding internal liner presence, fuel shape or size, etc. may be selected and implemented in any desired combination and with any other fuel changes during manufacture or through post-manufacturing modifications such as sintering, ablation, etching, reaming, polishing, etc. Variations may be used to achieve desired fuel properties and responses, such as through variations in fuel inventories, pressure drop, over-pressurization protection, etc. Example embodiment fuel rods may otherwise be compatible with existing fuel types and may be axially configured based on their radial position, including current or intended location within a fuel assembly and/or reactor core or current or intended location of a containing fuel assembly in a reactor core. For example, they may be configured to seat into and extend between upper and lower tie plates in a fuel assembly with spacers and a channel.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is an illustration of a section of a related art nuclear fuel assembly.

FIG. 2 is an illustration of an interior of a related art fuel rod.

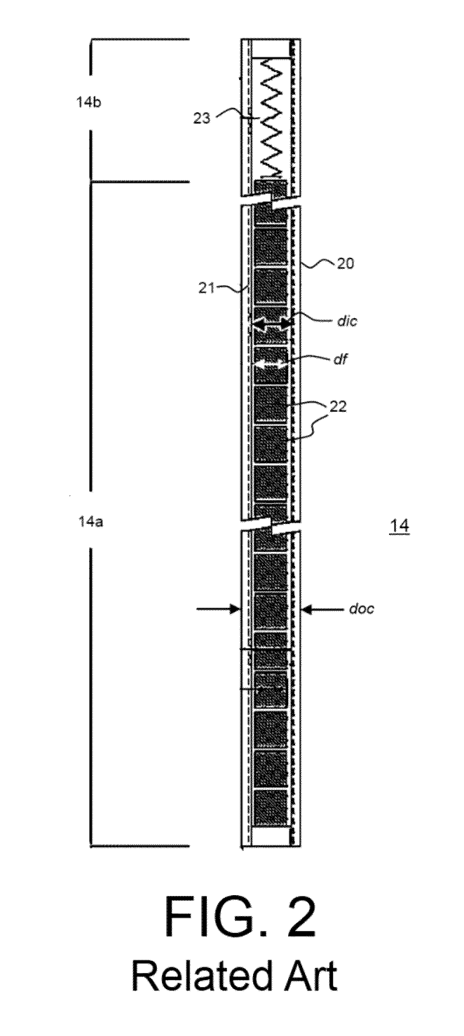

FIG. 3 is an illustration of an example embodiment fuel rod

FIG. 4 is an illustration of an example embodiment fuel rod.

### DETAILED DESCRIPTION

This is a patent document, and general broad rules of construction should be applied when reading and understanding it. Everything described and shown in this document is an example of subject matter falling within the scope of the appended claims. Any specific structural and functional details disclosed herein are merely for purposes of describing how to make and use example embodiments. Several different embodiments not specifically disclosed herein fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.). Similarly, a term such as “communicatively connected” includes all variations of information exchange routes between two devices, including intermediary devices, networks, etc., connected wirelessly or not.

As used herein, the singular forms “a”, “an” and “the” are intended to include both the singular and plural forms, unless the language explicitly indicates otherwise with words like “only,” “single,” and/or “one.” It will be further understood that the terms “comprises”, “comprising,”, “includes” and/or “including”, when used herein, specify the presence of stated features, steps, operations, elements, ideas, and/or components, but do not themselves preclude the presence or addition of one or more other features, steps, operations, elements, components, ideas, and/or groups thereof.

It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from the single operations described below. It should be presumed that any embodiment having features and functionality described below, in any workable combination, falls within the scope of example embodiments.

Applicants have recognized that nuclear fuel rods are exposed to neutronic and thermo-hydraulic conditions that can vary greatly with axial position in an operating nuclear reactor. Uniform fuel rod characteristics may not take advantage of, and/or may reduce fuel performance at, certain axial conditions that deviate from average or overall conditions across the entire rod length. Cladding thickness, fuel element shape, and/or fuel rod shape may not require uniformity, and can be individually adjusted to optimize fuel performance based on anticipated conditions at different axial positions. Applicants have recognized that any of fuel, cladding, and rod characteristics can be varied at fine axial lengths, based on radial positioning within the assembly, core, or other parameters to improve fuel rod performance, including safety margins, fuel mass and lifetime expectancy, and/or energy production efficiency, for example. Example embodiments described below address these and other problems recognized by Applicants with unique solutions enabled by example embodiments.

The present invention is a fuel rod that is useable to generate nuclear power with nuclear fuel contained in a cladding and/or fuel assemblies using such fuel rods. The present invention includes fuel rods with cladding that is intentionally varied at different axial positions and/or fuel elements that are intentionally varied at different axial positions. As used herein, “intentionally varied” is defined to exclude defects that inevitably occur as part of a manufacturing process or though damage as well as incidental changes that occur through operation, and terminations required to form an internal volume. In this way “intentionally varied” includes variations made during manufacture or as alterations thereafter of such a purposeful and substantial character to intentionally achieve different fuel rod responses. As used herein, “axial” is defined as the longest dimension of a whole fuel rod or assembly, often a vertical direction in operation.

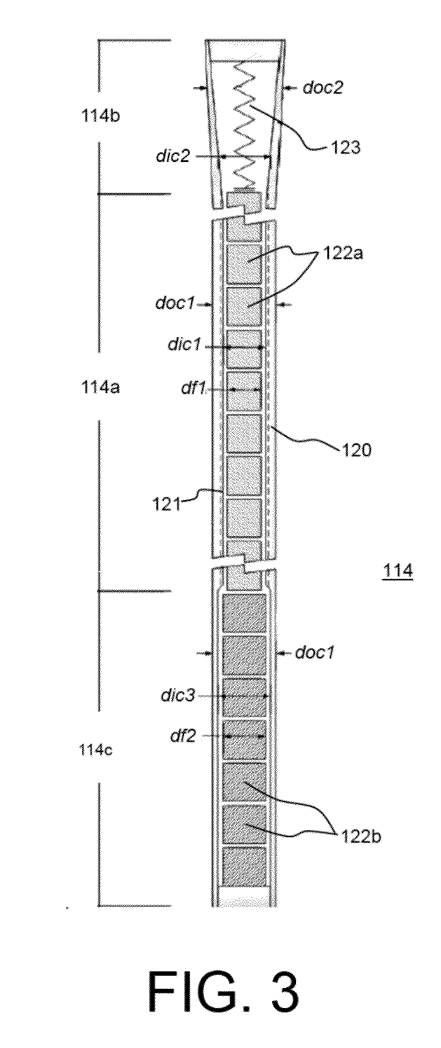

FIG. 3 is an illustration of a cross-section of an example embodiment fuel rod 114. As shown in FIG. 3, fuel rod 114 may include several similar features to conventional fuel rods and be useable in several different types of fuel assemblies in place of conventional fuel rods. Example embodiment fuel rod 114 includes a cladding 120 that houses and contains fuel elements 122, which may be, for example, cylindrical pellets, powders, prismatic solids, etc., providing fissile material for nuclear power generation. Fuel rod 114 may further include a hold down spring 123 or other stabilization device at any other position to secure fuel elements 122 within cladding 120.

As shown in FIG. 3, example embodiment fuel rod 114 has varying axial configurations. For example, a first zone 114a may be identified as an axial zone that will be exposed to operating conditions, such as changing moderator phase or varying control element exposure, within a nuclear reactor that are more likely to cause adverse interactions between fuel elements 122 and cladding 120 or more likely to be subject to damage or wear such that through spacer-induced fretting or puncture. First zone 114a may be, for example, an upper axial two-thirds of a fueled portion of example embodiment fuel rod 114. Based on the identification of expected conditions in first zone 114a, cladding 120 and/or fuel elements 122a may be configured to best accommodate these conditions. For example, cladding 120 may include a maximum or conventional thickness between outer diameter doc1 and inner diameter dic1 to reduce effects of fuel pellet/cladding interactions and failure. Fuel elements 122a arranged in first axial zone 114a may have a minimum or conventional width df1 in order to accommodate cladding inner diameter dic1 and increased cladding thickness.

A second axial zone, 114c may be identified as an axial zone that will be exposed to different operating conditions based on its position, such as one with less risk of cladding damage, fuel-cladding interaction, and/or benefiting from higher fuel inventories, for example. Second zone 114c may be, for example, a lower axial third of a fueled portion of example embodiment fuel rod 114. Based on the identification of expected conditions in second zone 114c, cladding 120 and/or fuel elements 122b may be configured to best accommodate these conditions. For example, cladding 120 may include a smaller thickness between outer diameter doc1 and inner diameter dic3 by removing inner liner 121 if present and/or thinning cladding in second axial zone 114c during manufacture or through later internal ablating, for example. Fuel elements 122b arranged in second axial zone 114c may have an increased width df2 in order to take advantage of the larger internal volume provided by a larger cladding inner diameter dic3 and decreased cladding thickness. For example, compared to some types of conventional light water fuel rods, dic3 may be increased by about 7 to 14 mils (thousandths of an inch) over dic1, with proportional increases to df2. Of course, other increases are useable in example embodiments.

By varying cladding and/or fuel parameters between axial zones 114a and 114c based on anticipated operating conditions at their respective positions, both axial and radial, safety margins and/or operating limits may be preserved, while fuel volume, neutronic response, and thermodynamic parameters may be optimized. For example, if second axial zone 114c in a lower third of example embodiment fuel rod 114, and cladding inner diameter dic3 in second axial zone 114c is increased with proportional fuel volume increase, Applicants have calculated that more kilograms of fissile uranium can be included in a typical BWR fuel assembly using example embodiment fuel rods 114, while preserving other safety and operating limits, over a rod using a single configuration over all axial positions.

Example embodiment fuel rod 114 may include additional axial variations. For example, A third axial zone, 114b may be identified as an axial zone that will be exposed to different operating conditions based on its position, such as one with less risk of cladding damage, fuel-cladding interaction, and/or benefiting from increased volume, for example. Third zone 114b may be, for example, an unfueled portion of example embodiment fuel rod 114 where fission products, such as gasses, accumulate. Based on the identification of expected conditions in third zone 114b, cladding 120 may be configured to best accommodate these conditions. For example, cladding 120 may include a smaller thickness between outer diameter doc2 and inner diameter dic2 by removing inner liner 121 if present, thinning cladding in third axial zone 114b during manufacture or through later shaping, for example. Cladding outer diameter doc2 may, for example, increase with axial height, and cladding inner diameter dic2 may increase at an even greater rate with axial height, resulting in a thinning cladding 120 with axial height. For example, compared to some types of conventional light water fuel rods, a thickness of cladding 120 between dic2 and doc2 may be decreased by about 3.5 to 7 mils (thousandths of an inch) in third axial zone 114b. Of course, several other decreases are useable in example embodiments.

By varying cladding parameters between axial zones 114a and 114b based on anticipated operating conditions at their respective positions, both axial and radial, safety margins and/or operating limits may be optimized. For example, if third axial zone 114b in an unfueled upper plenum position of example embodiment fuel rod 114 includes thinned cladding, plenum volume will be increased, which will allow for increased accommodation of fission gas and/or reduce rod internal pressures. Applicants have calculated that this permits an increase in thermal-mechanical operating limits and energy production efficiency, while preserving safety and operating limits, over a rod using a single configuration at all axial positions.

Although example embodiment fuel rod 114 has been described in three distinct axial zones 114a, b, and c with different cladding and/or fuel configurations in each based on anticipated operating conditions in those zones, it is understood that any number of different zones and cladding and/or fuel variances are useable in example embodiment fuel rod 114. Example embodiment fuel rods may include different unfueled areas and positions, different fuel enrichments, and/or different cladding thermo-mechanical and/or neutronic properties at different axial positions, for example. Such changes may be made or accounted for based on anticipated axial reactor conditions throughout the lifecycle of a fuel assembly containing example embodiment fuel rods.

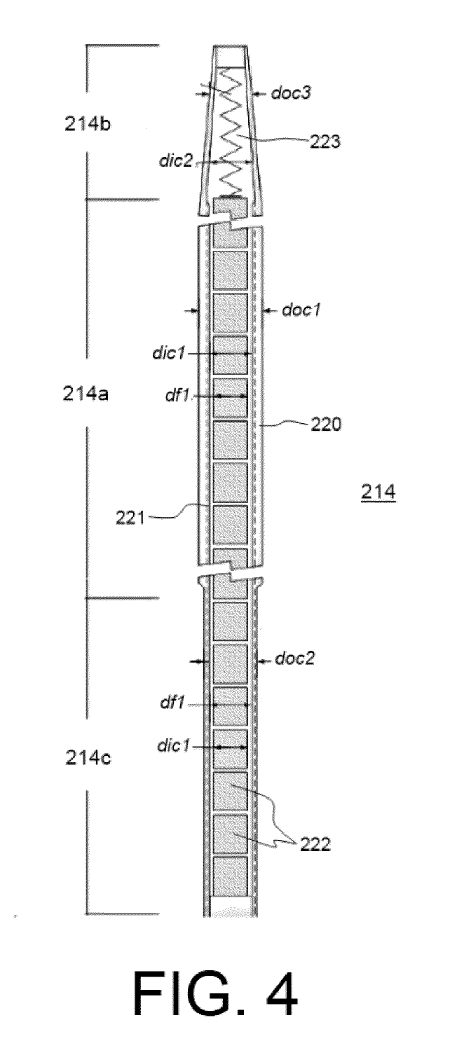

FIG. 4 is an illustration of a different example embodiment fuel rod 214 useable in nuclear reactors; fuel rod 214 may include several conventional features like a hold-down spring 223, cladding 220, inner liner 221 if present, and/or fuel elements 222. Example embodiment fuel rod 214 may include a first zone 214a that will be exposed to operating conditions where fuel inventories should not be increased and/or where cladding 220 should have a maximum or conventional thickness for safety or operational concerns. First zone 214a may be, for example, an upper axial two-thirds of a fueled portion of example embodiment fuel rod 214. Based on the identification of expected conditions in first zone 214a, cladding 220 and/or fuel elements 222 may be configured to best accommodate these conditions. For example, cladding 220 may include a maximum or conventional thickness between outer diameter doc1 and inner diameter dic1 to reduce effects of fuel pellet/cladding interactions and failure. Fuel elements 222 throughout example embodiment fuel rod 214 may have a standardized width df1.

Other axial zones, 214b and 214c may be identified as zones that will be exposed to different operating conditions due to their position, such as one with less risk of cladding damage, fuel-cladding interaction, and/or benefiting larger moderator volumes and/or decreased pressure drop, for example. Zone 214c may be, for example, a portion of a fueled portion of example embodiment fuel rod 214 while zone 214b may be an unfueled axial portion. Based on the identification of expected conditions in zones 214c and 214b, cladding 220 may be configured to best accommodate these conditions. For example, cladding 220 may be thinned in axial zones 214b. Outer diameter doc2 may be reduced in 214c while inner diameter dic1 and fuel element width df1 are held uniform, by thinning cladding in axial zone 214c during manufacture or through later external etching, for example. Similarly, cladding outer diameter doc3 may decrease with axial height in 214b, and inner diameter dic2 may increase. For example, doc3 and/or doc2 may be decreased by about 7 to 14 mils over doc1. Of course, other decreases are useable in example embodiments.

By varying cladding sizing and fuel rod outer diameter between axial zones 214a, b, and c based on anticipated operating conditions at their respective positions, both axial and radial, safety margins and/or operating limits may be optimized. For example, axial zones 214b and 214c may provide a lower pressure drop to a fluid coolant/moderator flowing axially along fuel rod 214 and/or provide for better moderation, providing for improved hydrodynamic performance and plant efficiency.

Although example embodiment fuel rods 114 and 214 in FIGS. 3 and 4 have been described with particular combinations of axial properties, it is understood that any single feature may be present in example embodiments, and other combinations can be present in an example embodiment fuel rod in any number of axial zones. For example, an engineer wishing to use example embodiment fuel rods having a constant outer diameter that matches the outer cladding diameter of conventional fuel rods, so that example embodiment fuel rods can replace conventional fuel rods, may implement only the variation from zone 114c of FIG. 3 for use at desired axial positions. In this way, outer diameter doc1 may remain constant along an entire example embodiment fuel rod and mimic conventional fuel rods' geometry while providing optimization advantages through increased inner diameter and fuel mass. Or, for example, a fuel fabricator wishing to use fuel elements of a single size for manufacturing compatibility and modularity may use example embodiment fuel rod 214 from FIG. 4 with a single, uniform configuration for fuel elements 222 while providing hydrodynamic and other advantages through outer diameter decreases at particular axial positions.

Still further, a nuclear fuel provider may apply any or all modifications across several different axial zones and among various fuel assembly positions to achieve desired fuel rod response. For example, a narrowed outer and inner diameter dic2/doc3 from zone 214b of example embodiment fuel rod 214 may be used in an unfueled lower plenum position, wider inner diameter and fuel width dic3/df2 from zone 114c of example embodiment fuel rod 114 may be used at several axial positions where larger fuel inventories are desired based on fuel assembly or reactor core parameters, narrower outer diameter doc2 from zone 214c of example embodiment fuel rod 214 may be used at a higher zone where lower pressure drop and more moderator volume is desired, and widened outer and inner diameter dic2/doc2 from zone 114b of example embodiment fuel rod 114 may be used at a terminal unfueled plenum region to provide larger fission product accommodation. Yet further, the engineer can mix features within a same zone; for example, both an cladding inner diameter may be increased and a cladding outer diameter decreased in cladding for a particular zone, combining a lower pressure drop and larger fuel volume in that zone.

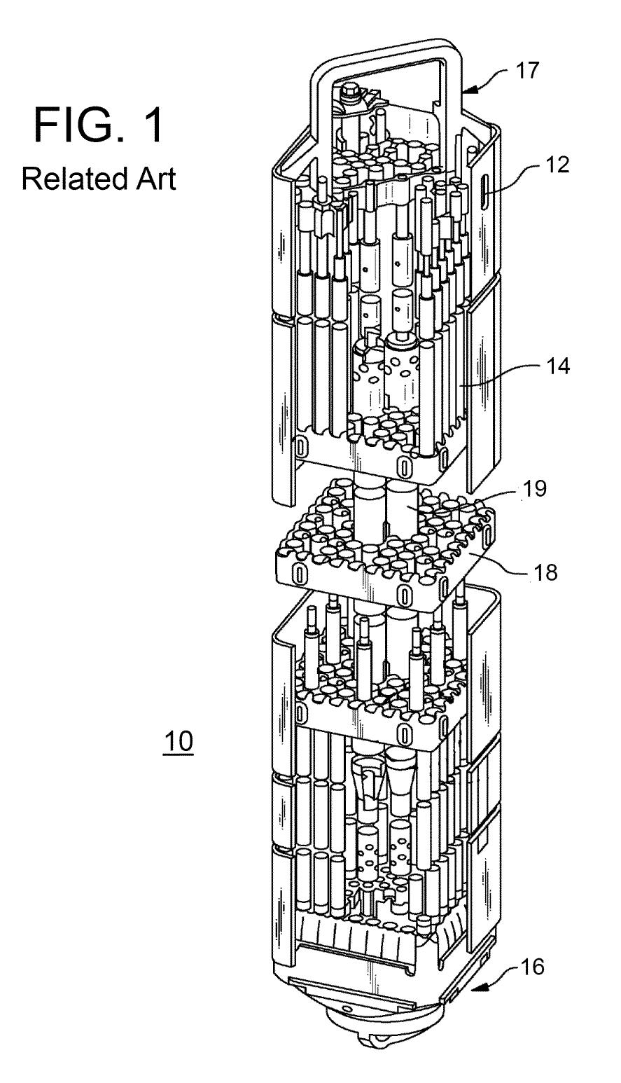

Example embodiment fuel rods are useable in a variety of reactor and fuel assembly types. Example embodiment fuel rods can be configured to be used in the assemblies 10 of FIG. 1 and replace conventional rods 14 within fuel assemblies. Individual example embodiment fuel rods include axial variations based on anticipated reactor operating conditions and a favorable response thereto. Thus, several example embodiment fuel rods within an assembly may have axial features configured based on anticipated bundle placement as well as the effects of each other on operating conditions. In this way example embodiment fuel rods permit a core designer to more finely adjust core response and operating characteristics and potentially achieve improved burnup, fuel lifetime, operating and safety margins, and/or improved plant efficiency.

Example embodiments and methods thus being described, it will be appreciated by one skilled in the art that example embodiments may be varied and substituted through routine experimentation while still falling within the scope of the following claims. For example, although some example embodiments are described with unfueled areas only in a top axial position and modular fuel structures, it is understood that example embodiment fuel rods may include any combination of unfueled and fueled zones, as well as different types, shapes, and enrichments for fuel elements. Further, it is understood that example embodiments and methods can be used in connection with any type of fuel and reactor where fuel rods are used, including BWR, PWR, heavy-water, fast-spectrum, graphite-moderated, etc. reactors. All cladding and fuel size values given above are exemplary and do not in any way limit the independent claims. Such variations are not to be regarded as departure from the scope of the following claims.

What is claimed is:

1. A fuel rod for use in a nuclear fuel assembly, the fuel rod comprising:
a nuclear fuel element; and
a cladding having an inner diameter that defines an impermeable internal volume in which the nuclear fuel element is contained, wherein the cladding extends in an axial direction perpendicular to the inner diameter, and wherein the inner diameter intentionally varies along the axial direction.

2. The fuel rod of claim 1, wherein the inner diameter varies by at least 3.5 mil.

3. The fuel rod of claim 1, wherein the nuclear fuel element includes a first fuel pellet and a second fuel pellet stacked axially in the internal volume, and wherein the first fuel pellet and the second fuel pellet have an intentionally different volume.

4. The fuel rod of claim 3, wherein the first and the second fuel pellets are cylindrical and have intentionally different diameters based on the inner diameter of the cladding.

5. The fuel rod of claim 4, wherein the first and second fuel pellets each have a constant diameter that is different by at least 3.5 mil from the other.

6. The fuel rod of claim 1, wherein the cladding is cylindrical and includes an outer diameter, and wherein the outer diameter is constant such that a thickness of the cladding varies along the axial direction.

7. The fuel rod of claim 1, wherein the internal volume includes a non-fueled region in which fission products may accumulate, and wherein the inner diameter is larger in the non-fueled region than in a fueled region.

8. The fuel rod of claim 7, wherein,
the cladding is cylindrical and includes an outer diameter,
the outer diameter is larger in the non-fueled region than in the fueled region, and
the non-fueled region is at a terminal axial position where the fuel rod is configured to seat into a tie plate.

9. The fuel rod of claim 1, wherein the inner diameter intentionally varies based on a radial position of the fuel rod in a nuclear fuel assembly and in a reactor core.

10. The fuel rod of claim 1, wherein the cladding includes an outer diameter, and wherein the outer diameter intentionally varies along the axial direction.

11. A fuel rod for use in a nuclear fuel assembly, the fuel rod comprising:
a nuclear fuel element; and
a cladding having an outer diameter and an inner diameter that defines an impermeable internal volume in which the nuclear fuel element is contained, wherein the cladding extends in an axial direction perpendicular to the inner and the outer diameters, and wherein the outer diameter intentionally varies along the axial direction such that at least two different thirds of the fueled region of the rod have completely different outer diameters.

12. The fuel rod of claim 11, wherein the outer diameter varies by at least 3.5 mil.

13. The fuel rod of claim 11, wherein the internal volume includes a non-fueled region in which fission products may accumulate, and wherein the outer diameter is smaller in the non-fueled region than in the fueled region.

14. The fuel rod of claim 13, wherein the inner diameter is larger in the non-fueled region than in the fueled region so that a thickness of the cladding is less in the non-fueled region than in the fueled region.

15. The fuel rod of claim 13, wherein the non-fueled region is at a terminal axial position where the fuel rod is configured to seat into a tie plate, and wherein the non-fueled region includes a hold-down spring.

16. The fuel rod of claim 11, wherein the inner diameter intentionally varies along the axial direction, and wherein the inner diameter is formed by an inner liner that may be absent at axial positions and present at others.

17. The fuel rod of claim 11, wherein the nuclear fuel element includes a first fuel pellet and a second fuel pellet stacked axially in the internal volume, and wherein the first fuel pellet and the second fuel pellet have an intentionally different volume.

18. The fuel rod of claim 17, wherein the first and the second fuel pellets are cylindrical and have diameters that vary based on the inner diameter of the cladding.

19. A nuclear fuel assembly comprising:
a plurality of fuel rods extending in an axial direction, wherein at least one of the fuel rods includes,
a nuclear fuel element, and
a cladding having an inner diameter that defines an impermeable internal volume in which the nuclear fuel element is contained, wherein the cladding extends in an axial direction perpendicular to the inner diameter, and wherein the inner diameter intentionally varies along the axial direction;
a spacer through which the fuel rods pass, wherein the spacer includes; and
a channel surrounding the plurality of fuel rods.

20. The fuel assembly of claim 19, wherein the cladding further includes an outer diameter, and wherein the outer diameter intentionally varies along the axial direction for at least a third of a fueled region of the rod.
